(19) United States
(12) Patent Application Publication
(10) Pub. No.: US 2020/0010281 A1
(43) Pub. Date: Jan. 9, 2020

(54) CONVEYOR APPARATUS, CONVEYOR SYSTEM, AND METHOD OF OPERATING CONVEYOR APPARATUS

(71) Applicant: Kabushiki Kaisha Yaskawa Denki, Kitakyushu-shi (Fukuoka ) (JP)

(72) Inventors: Haruhiko Koike, Kitakyushu-shi (Fukuoka ) (JP); Kanji Watanabe, Kitakyushu-shi (Fukuoka ) (JP); Yasuhiko Kaku, Kitakyushu-shi (Fukuoka ) (JP); Koji Hara, Kitakyushu-shi (Fukuoka ) (JP)

(21) Appl. No.: 16/566,159

(22) Filed: Sep. 10, 2019

Related U.S. Application Data
(63) Continuation-in-part of application No. PCT/JP2017/010749, filed on Mar. 16, 2017.

(51) Int. Cl. B65G 43/00

(52) U.S. Cl. CPC B65G 43/00; B65G 2811/095; B65G 2811/093; B65G 2203/0291

(57) ABSTRACT

According to the present disclosure, a conveyor apparatus includes a conveyor frame, a belt provided on the conveyor frame, a motor configured to drive the belt, and a control device configured to control the motor. The control device includes a servo control device configured to control the motor based on a command from a controller, and an inverter control device configured to control the speed of the motor based on an input signal from a speed variable volume.

### CROSS-REFERENCE TO RELATED APPLICATIONS

This application is a Continuation-in-part of International Application No. PCT/JP2017/010749, filed on Mar. 16, 2017, which is incorporated herein in its entirety by reference.

### TECHNICAL FIELD

The embodiments of the present disclosure relate to a conveyor apparatus, a conveyor system, and a method of operating the conveyor apparatus.

### BACKGROUND

Japanese Patent No. 4618448 (Patent Document 1) describes an alignment conveyor apparatus. This alignment conveyor apparatus includes a plurality of alignment conveyors each connected to a servo driver and an output conveyor connected to an inverter.

### SUMMARY

According to one aspect of the present disclosure, there is provided a conveyor apparatus including: a conveyor frame; a conveyor provided in the conveyor frame; a motor configured to drive the conveyor; control circuitry configured to control the motor, and including a first controller configured to control a position of the motor based on a position command from a host controller and a second controller configured to control a speed of the motor based on an input signal from a first operation input switch; a first operation panel configured to perform an operation input to the first controller; a second operation panel provided with the first operation input switch and configured to perform an operation input to the second controller; and a housing integrally equipped with the first operation panel and the second operation panel.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an appearance view illustrating an example of an entire configuration of a conveyor apparatus according to a first embodiment, when viewed from one side of the conveyor apparatus in a width direction.

FIG. 2 is an appearance view illustrating an example of an inverter-side operation panel of a control box provided in the conveyor apparatus.

FIG. 3 is an appearance view illustrating an example of an entire configuration of the conveyor apparatus when viewed from the other side of the conveyor apparatus in the width direction.

FIG. 4 is an appearance view illustrating an example of a servo-side operation panel of the control box provided in the conveyor apparatus.

FIG. 5 is a block diagram illustrating an example of a functional configuration of a control device in a conveyor apparatus according to a first embodiment.

FIG. 6 is a block diagram illustrating an example of a functional configuration of a control device in a conveyor apparatus according to a second embodiment.

FIG. 7 is a block diagram illustrating an example of a functional configuration of a control device in a conveyor apparatus according to a third embodiment.

FIG. 8 is an explanatory view illustrating an example of an inverter-side operation panel and a cover according to a modified embodiment where the cover is provided on an operation panel not being used.

FIG. 9 is an explanatory view illustrating an example of a servo-side operation panel and a cover according to a modified embodiment where the cover is provided on an operation panel not being used.

FIG. 10 is an appearance view illustrating an example of an entire configuration of a conveyor apparatus when viewed from one side of the conveyor apparatus in the width direction, according to a modified embodiment where an inverter-side operation panel and a servo-side operation panel are arranged side by side at the same side of the conveyor apparatus.

FIG. 11 is an explanatory view illustrating an example of a configuration of a control box according to a modified embodiment where the control box is rotatably provided.

FIG. 12 is an explanatory view illustrating an example of a hardware configuration of a controller of the conveyor apparatus.

FIG. 13 is a flowchart illustrating an operation of the conveyor apparatus according to an embodiment.

FIG. 14 is a flowchart illustrating an operation of the conveyor apparatus according to another embodiment.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

In a conveyance line (e.g., a production line or a distribution line) which uses a conveyor apparatus, a conveyance volume or conveyance contents may vary according to, for example, market trends or seasons. The configuration of the alignment conveyor apparatus of the related art is required to be further optimized, in order to flexibly cope with the variance of the conveyance volume or the conveyance contents while reducing the number of idling conveyors.

Non-limiting embodiments of the present disclosure relate to providing a conveyor apparatus, a conveyor system, and a method of operating the conveyor apparatus which are capable of flexibly coping with the variance in conveyance volume or conveyance contents while reducing the number of idling facilities.

According to one aspect of the present disclosure, there is provided a conveyor apparatus including: a conveyor frame; a conveying member provided on the conveyor frame; a motor configured to drive the conveying member; and a control device configured to control the motor. The control device includes a first controller configured to control the position of the motor based on a position command from a host control device, and a second controller configured to control the speed of the motor based on an input signal from a first operation input unit.

According to another aspect of the present disclosure, there is provided a conveyor apparatus including: a conveyor frame; a conveying member provided on the conveyor frame; a motor configured to drive the conveying member; and a control device configured to control the motor. The control device includes a first connector configured to communicate with a host control device, a first operation input unit configured to change the speed of the motor, and a second operation input unit configured to switch the control of the motor to an automatic control based on a command from the host control device or to a manual control based on an input signal from the first operation input unit.

According to yet another aspect of the present disclosure, there is provided a conveyor apparatus including: a conveyor frame; a conveying member provided on the conveyor frame; a first motor and a second motor each configured to drive the conveying member; and a control device configured to control the first motor and the second motor. The control device includes a first controller configured to control the position of the first motor based on a position command from a host control device, a second controller configured to control the speed of the second motor based on an input signal from a first operation input unit, and a second operation input unit configured to perform a switching operation between the first controller and the second controller, and the first motor and the second motor are a single common motor.

According to yet another aspect of the present disclosure, there is provided a conveyor system including: a host control device; and a conveyor apparatus that is connected to the host control device so as to be able to communicate with the host control device such that the control device is switched to the first controller.

According to yet another aspect of the present disclosure, there is provided a method of operating a conveyor apparatus including a conveyor frame, a conveying member provided on the conveyor frame, a motor configured to drive the conveying member, and a control device configured to control the motor. The method includes: switching the control device to a first controller configured to control the position of the motor based on a position command from a host control device, when the conveyor apparatus is subjected to an automatic operation; and switching the control device to a second controller configured to control the speed of the motor based on an input signal from a first operation input unit, when the conveyor apparatus is subjected to a manual operation.

According to the present disclosure, it is possible to flexibly cope with the variance in conveyance volume or conveyance contents while reducing the number of idling conveyors.

### 0. Background of Present Disclosure

Prior to describing the embodiments, descriptions will be made first on the circumstances that the inventors of the present disclosure have considered as a result of intensive researches.

Recently, for example, in a food factory, a conveyor apparatus such as a belt conveyor has been used for conveying commodities such as food. Since food is a seasonal commodity, the conveyance volume or the conveyance contents vary frequently. In the food factory, an automation may not be progressed, and in that case, a conveyor apparatus having a low performance is used with labor-oriented human resources. That is, an operator changes the conveyor speed manually by changing the output frequency of an inverter control device using, for example, a variable volume, and sets the speed of the production line as necessary each time according to the production amount and available workers.

Meanwhile, in some cases, an automation of the factory may be progressed for the purpose of, for example, resolving the shortage of available workers, and in that case, a production line in which, for example, a manufacturing apparatus, a robot, and an apparatus conveyor are combined with each other is constructed in some processes. In this case as well, a conveyor apparatus may be used, and a high performance conveyor apparatus may be used in order to implement a synchronized operation with a robot, a conveyor apparatus for a system, and a controller system provided with various sensors. That is, the conveyor apparatus may be provided with a servo motor and a servo control device, and the servo control device may conduct a data communication with a controller to perform an advanced synchronization control.

In a food factory, for example, when a large amount of seasonal food is temporarily produced, it may be difficult to secure enough workers for each season, and hence, there is a demand for constructing a highly automated line. However, since the seasonal food may no longer be produced as the season changes, the production amount or production contents may change, and thus, the automated line for the seasonal food may not cope with the change. In this case, since a machine is less flexible than a human labor, for example, it may be conceived to remove the high performance conveyor apparatus of the existing automated line, arrange human workers between processing apparatuses, and provide the low performance conveyor apparatus described above to construct a manual line. Further, it may also be conceived to return to the automated line in which the high performance conveyor apparatus described above is provided, when the season changes. In this case, both the low performance conveyor apparatus and the high performance conveyor apparatus are necessary, but since any one of the apparatuses becomes unnecessary according to the seasons, the factory requires an extra space for storing the conveyor apparatus not being used. Further, since there exists a conveyor apparatus which becomes an idling facility for time periods throughout the year, a wasted investment may occur. Accordingly, it becomes difficult to progress the advanced automation of the conveyance between manufacturing apparatuses, which may be considered as a main cause for the delay of the automation. Thus, this remains a problem sought to be solved, in promoting the automation of a factory line for resolving the shortage of workers in the future.

The problem described above is caused from the fact that the uses of the low performance conveyor apparatus and the high performance conveyor apparatus are entirely different. That is, in the low performance conveyor apparatus, a worker in the field directly and manually changes the conveyor speed as necessary in order to cope with a variance in daily production amount or available workers. In general, since the worker in the field may not be a technician and may not be able to perform a specialized operation, the conveyor apparatus is provided with, for example, a variable volume that changes the conveyor speed or switches for driving and stop. Meanwhile, in the high performance conveyor apparatus, a professional technician who constructs a production line performs installation and adjustment works such as a connection with a controller and a setting of parameters of a servo control device. Thus, the conveyor apparatus requires, for example, a connector for the connection with the controller and a parameter setting device.

The inventors of the present disclosure have taken the foregoing circumstances into account, and conceived to make the high performance conveyor apparatus provided with the same component as that of the low performance conveyor apparatus. That is, a servo motor that drives the conveyor apparatus may be provided in common to be driven as either the inverter control device or the servo control device. Hereinafter, details of the present disclosure will be described. In addition, for example, the solution and the effects described above are merely examples according to the embodiments to be described herein below, and it is needless to say that each embodiment exhibits, for example, new operational effects.

### 1. First Embodiment

A first embodiment will be described with reference to the accompanying drawings. In the descriptions herein below, the directions such as a width direction, an up-and-down direction, and a conveyance direction will be appropriately used for the convenience of description of a configuration of, for example, a conveyor apparatus, but are not intended to limit the positional relationship of respective components of the conveyor apparatus. In the descriptions herein below, the width direction refers to the direction of the shorter length of the conveyor apparatus, the up-and-down direction refers to the vertical direction, and the conveyance direction refers to the longitudinal direction of the conveyor apparatus.

### 1-1. Entire Configuration of Conveyor Apparatus

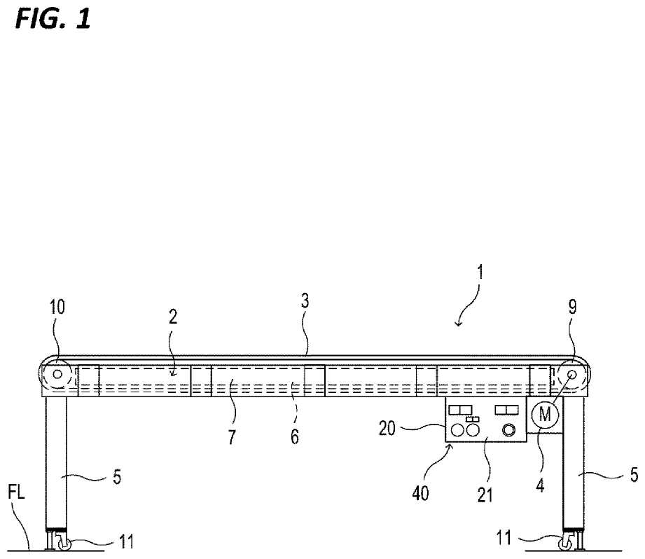

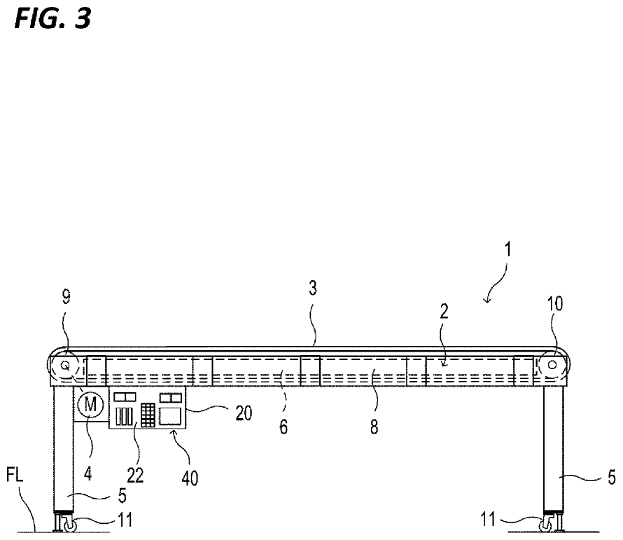

An example of an entire configuration of a conveyor apparatus 1 according to a first embodiment will be described with reference to FIGS. 1 and 3. FIG. 1 is an appearance view illustrating an example of the entire configuration of the conveyor apparatus 1 of the present embodiment when viewed from one side of the conveyor apparatus 1 in the width direction. FIG. 3 is an appearance view illustrating an example of the entire configuration of the conveyor apparatus 1 when viewed from the other side of the conveyor apparatus 1 in the width direction.

As illustrated in FIG. 1, the conveyor apparatus 1 includes a conveyor frame 2, a belt 3, a motor 4, and a control device 40.

The conveyor frame 2 includes a base 6 provided along the conveyance direction of the conveyor apparatus 1 (the right and left direction in FIG. 1), a plurality of supports 5 that support the base 6, a lateral plate 7 provided on one side of the base 6 in the width direction perpendicular to the conveyance direction (the front side of the plane of FIG. 1), and a lateral plate 8 (see FIG. 3) provided on the other side of the base 6 in the width direction (the back side of the plane of FIG. 1).

A caster 11 that includes an adjuster is provided at the lower end of each support 5 to install the conveyor apparatus 1 on the floor FL. With the caster 11, the conveyor apparatus 1 may be easily moved or the direction of the conveyor apparatus 1 may be easily changed (e.g., the conveyor apparatus 1 in the state of FIG. 1 may be rotated 180° around a vertical axis to become the state of FIG. 3). In addition, the caster 11 may not necessarily be provided. Between the lateral plates 7 and 8, a driving roller 9 is rotatably supported at the ends of the lateral plates 7 and 8 on one side in the conveyance direction (e.g., the right side in FIG. 1 and the left side in FIG. 3), and a driven roller 10 is rotatably supported at the ends of the lateral plates 7 and 8 on the other side in the conveyance direction (e.g., the left side in FIG. 1 and the right side in FIG. 3).

The belt 3 (e.g., an example of a conveying member) is wound endlessly around the driving roller 9 and the driven roller 10, and disposed horizontally along the conveyance direction between the lateral plates 7 and 8. In addition, in the present embodiment, descriptions are made on a case where the conveyor apparatus 1 is a belt conveyor provided with the belt 3 as the conveying member. However, the conveying member is not limited to the belt and may be, for example, a chain or a roller.

The motor 4 is a servo motor, and for example, a synchronous motor provided with a permanent magnet. The motor 4 is provided, for example, at the lower end of the lateral plate 7 on one side in the conveyance direction as described above, such that an output shaft (not illustrated) protrudes from the lower end of the lateral plate 7 toward one side in the width direction. The output shaft of the motor 4 is connected to the driving roller 9 via a speed reduction gear (not illustrated), to rotate the driving roller 9 thereby driving the belt 3. In addition, the installation position of the motor 4 may be a position other than the position described above.

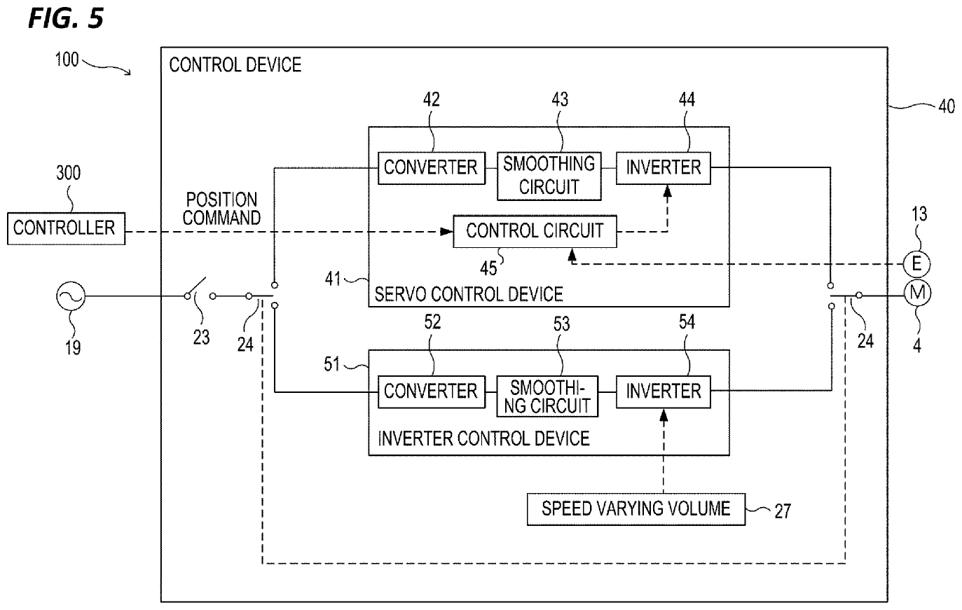

The control device 40 controls the driving of the motor 4. As illustrated in FIG. 5, the control device 40 includes a servo control device 41 and an inverter control device 51. Details of the control devices will be described later. As illustrated in FIG. 1, the control device 40 includes a control box 20 (e.g., an example of a housing) provided on the lower surface of the conveyor frame 2 and having, for example, a substantially cuboid shape. In this example, the control box 20 is provided near the motor 4 across both the lower ends of the lateral plates 7 and 8.

### 1-2. Panel Configuration of Control Device

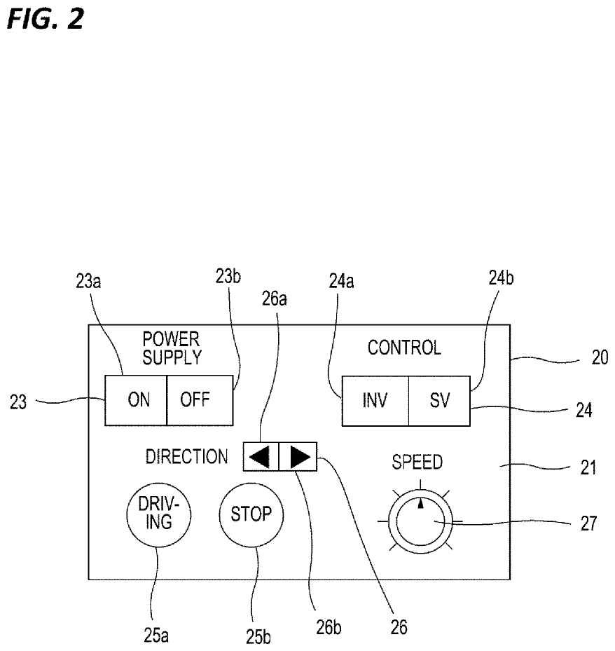

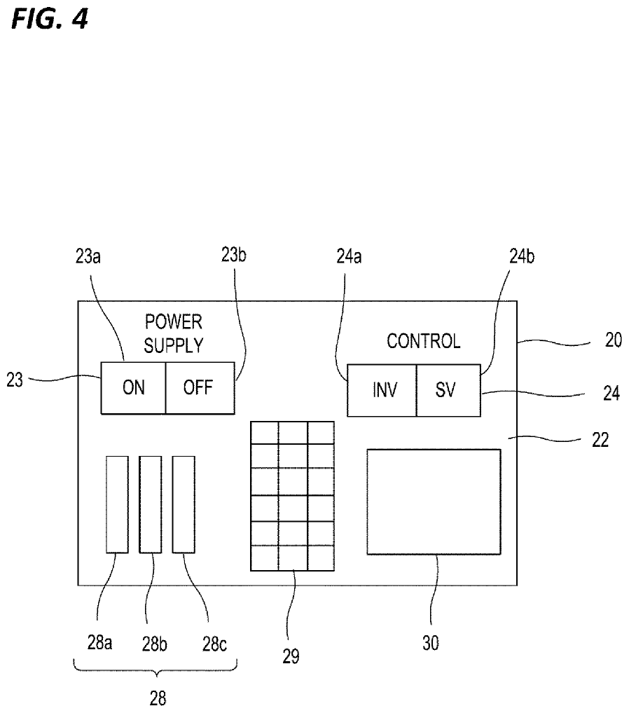

Next, an example of a panel configuration of the control device 40 will be described with reference to, for example, FIGS. 2 and 4. FIG. 2 is an appearance view illustrating an example of an inverter-side operation panel of the control device. FIG. 4 is an appearance view illustrating an example of a servo-side operation panel of the control device.

As illustrated in FIGS. 2 and 4, an inverter-side operation panel 21 (e.g., an example of a second operation panel) and a servo-side operation panel 22 (e.g., an example of a first operation panel) are arranged in the control box 20 to face different directions. In this example, the inverter-side operation panel 21 is disposed at one side of the control box 20 in the width direction, and the servo-side operation panel 22 is disposed at the other side of the control box 20 in the width direction.

As illustrated in FIG. 2, various control elements such as, for example, a power supply switch 23 of the conveyor apparatus 1, a control changeover switch 24 that performs a switching operation between an inverter control and a servo control of the motor 4, a driving switch 25a that starts the driving of the conveyor apparatus 1 (e.g., an example of a third operation input unit), a stop switch 25b that stops the driving of the conveyor apparatus 1 (e.g., an example of a third operation input unit), a direction changeover switch 26 that switches the conveyance direction of the conveyor apparatus 1, and a speed variable volume 27 are arranged in the inverter-side operation panel 21.

The power supply switch 23 includes a switch section 23a that corresponds to an “ON” switch section and a switch section 23b that corresponds to an “OFF” switch section. As for the power supply switch 23, various types of switches such as, for example, a push button type switch and a toggle switch may be used. When, for example, the switch section 23a is operated, power is supplied from an AC power supply 19 to the conveyor apparatus 1. When, for example, the switch section 23b is operated, the supply of power to the conveyor apparatus 1 is cut off. In addition, for example, each of the switch sections 23a and 23b may be lighted, to also serve as a display that displays the ON or OFF state of the power supply.

The control changeover switch 24 (e.g., an example of a second operation input unit) includes two switch sections 24a and 24b. As for the control changeover switch 24, various types of switches such as, for example, a push button type switch and a toggle switch may be used. When, for example, the switch section 24a is operated, the inverter control device 51 (see, e.g., FIG. 5) is selected to be connected to the AC power supply 19 and also connected to the motor 4, such that the control of the motor 4 is switched to the inverter control. In addition, when, for example, the switch section 24b is operated, the servo control device 41 (see, e.g., FIG. 5) is selected to be connected to the AC power supply 19 and also connected to the motor 4, such that the control of the motor 4 is switched to the servo control. In addition, for example, each of the switch sections 24a and 24b may be lighted, to also serve as a display that displays the type of control.

The direction changeover switch 26 includes two switch sections 26a and 26b. As for the direction changeover switch 26, various types of switches such as, for example, a push button type switch and a toggle switch may be used. When, for example, the switch section 26a is operated, the conveyance direction of the conveyor apparatus 1 is switched to, for example, the direction toward the driven roller 10 from the driving roller 9, and when, for example, the switch section 26b is operated, the conveyance direction of the conveyor apparatus 1 is conversely switched to the direction toward the driving roller 9 from the driven roller 10. In addition, for example, each of the switch sections 26a and 26b may be lighted, to also serve as a display that displays the conveyance direction.

The speed variable volume 27 (e.g., an example of a first operation input unit) is an operation input unit that inputs a speed control input signal to the inverter control device 51, and is configured by, for example, a variable resistor. When the speed variable volume 27 is rotated, a speed control input signal corresponding to an amount of the rotation is input to the inverter control device 51. In addition, instead of the speed variable volume 27, for example, a touch panel capable of inputting a speed value may be used.

As illustrated in FIG. 4, various control elements such as, for example, a power supply switch 23 of the conveyor apparatus 1, a control changeover switch 24 that performs a switching operation between the inverter control and the servo control of the motor 4, a plurality of connectors 28, an input key 29, and a display 30 are arranged in the servo-side operation panel 22.

The power supply switch 23 of the servo-side operation panel 22 has the same configuration as that of the power supply switch 23 of the inverter-side operation panel 21. That is, the inverter-side operation panel 21 and the servo-side operation panel 22 are configured such that the ON or OFF operation of the power supply may be performed from any of the operation panels 21 and 22.

The control changeover switch 24 of the servo-side operation panel 22 also has the same configuration as that of the control changeover switch 24 of the inverter-side operation panel 21. That is, the inverter-side operation panel 21 and the servo-side operation panel 22 are configured such that the switching operation between the inverter control and the servo control may be performed from any of the operation panels.

The plurality of connectors 28 include a plurality of connectors 28a to 28c (e.g., three connectors). For example, a cable is connected to the first connector 28a to communicate with a controller 300 (e.g., an example of a host control device). Alternatively, the first connector 28a may communicate with the controller 300 in a wireless communication. An encoder cable is connected to the second connector 28b to communicate with an encoder 13 provided in the motor 4. An external terminal such as a PC is connected to the third connector 28c to, for example, set parameters of the servo control device 41. In addition, other connectors may be provided instead of or in addition to the connectors 28a to 28c.

The input key 29 includes, for example, command keys or number keys for inputting various commands or information. The display 30 is configured by, for example, a liquid crystal display or a touch panel, and displays various kinds of information.

In addition, the panel configuration described above is merely an example, and the present disclosure is not limited to the configuration descried above. For example, the control changeover switch 24 may not be provided on the inverter-side operation panel 21, and may be provided only on the servo-side operation panel 22. That is, a worker who operates the inverter-side operation panel 21 may not perform the switching of the control, and only a technician who operates the servo-side operation panel 22 may perform the switching of the control. In addition, the inverter-side operation panel 21 may not necessarily include, for example, the direction changeover switch 26, and may be configured to include only, for example, the driving switch 25a, the stop switch 25b, and the speed variable volume 27.

In addition, for example, the power supply switch 23 or the control changeover switch 24 may not be provided on the inverter-side operation panel 21 or the servo-side operation panel 22, and may be provided individually or in common at a separate position. In this case, the control changeover switch 24 may be provided outside the conveyor apparatus 1 (e.g., the control changeover switch 24 may be provided at a host controller, an external terminal or an external switch). In addition, the servo-side operation panel 22 may not necessarily include the input key 29 or the display 30, and may be configured to include, for example, only the control changeover switch 24 and the connector 28.

### 1-3. Functional Configuration of Control Device

Next, an example of a functional configuration of the control device 40 will be described with reference to FIG. 5. FIG. 5 is a block diagram illustrating an example of the functional configuration of the control device.

As illustrated in FIG. 5, the control device 40 includes the servo control device 41 (e.g., an example of a first controller) and the inverter control device 51 (e.g., an example of a second controller). The servo control device 41 includes a converter 42, a smoothing circuit 43, an inverter 44, and a control circuit 45. In the servo control device 41, the converter 42 converts an AC power supplied from the AC power supply 19 into a DC power, the smoothing circuit 43 smooths the converted DC power, the inverter 44 converts the smoothed DC power into an AC power of a predetermined frequency based on a control signal from the control circuit 45, and the converted AC power is supplied to the motor 4. The control circuit 45 controls the inverter 44 based on a deviation between a position command (or a speed command) from the controller 300 and a detected position (or a detected speed) of the motor 4 which is fed back from the encoder 13. In this way, the servo control device 41 controls a rotational position (or a rotation speed) of the motor 4 based on the command from the controller 300.

The inverter control device 51 includes a converter 52, a smoothing circuit 53, and an inverter 54. In the inverter control device 51, the converter 52 converts an AC power supplied from the AC power supply 19 into a DC power, the smoothing circuit 53 smooths the converted DC power, the inverter 54 converts the smoothed DC power into an AC power of a predetermined frequency based on an input signal from the speed variable volume 27, and the converted AC power is supplied to the motor 4. In this way, the inverter control device 51 controls the speed of the motor 4 based on the input signal from the speed variable volume 27. In addition, for example, an operation input unit such as the speed variable volume 27 may be provided in the controller 300, and a speed control signal may be input from the controller 300 to the inverter control device 51.

The servo control device 41 and the inverter control device 51 are switched by the control changeover switch 24 to control the single common motor 4. Since the motor 4 is a servo motor, and for example, a synchronous motor provided with a permanent magnet as described above, the speed of the motor 4 may be controlled not only by the servo control device 41 but also by the inverter control device 51 without causing any problem.

In addition, the controller 300 and the conveyor apparatus 1 in which the control device 40 is switched to the servo control device 41 constitute a conveyor system 100.

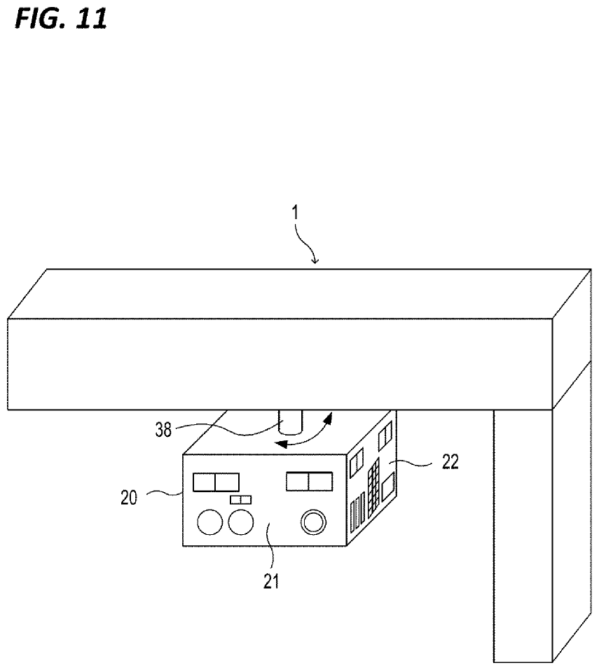

In addition, for example, the foregoing processes in the control circuit 45 and other elements are not limited to the example of the process distribution described above, and for example, the processes may be performed by a smaller number of processing units (e.g., a single processing unit) or further sub-divided processing units. In addition, in the servo control device 41 and the inverter control device 51, only the portions that supply the driving power to the motor 4 (e.g., the converter, the smoothing circuit, and the inverter) may be implemented by actual devices, and the other functions may be implemented by computer programs executed by a CPU 901 to be described later (see, e.g., FIG. 11). In addition, a portion or entire portion of the servo control device 41 and the inverter control device 51 may be implemented by actual devices such as an ASIC, an FPGA, and other electric circuits.

### 1-4. Method of Operating Conveyor Apparatus

When the conveyor apparatus 1 having the configuration described above is used as a high performance conveyor apparatus, that is, when the conveyor apparatus 1 is subjected to an automatic operation, a technician may operate the switch section 24b on the servo-side operation panel 22 (or the inverter-side operation panel 21), to switch the control of the motor 4 to the servo control. Then, the technician may perform an adjustment work such as a work of wiring with, for example, the controller 300 or a parameter setting in accordance with the configuration of a conveyance line (e.g., a production line or a distribution line).

Meanwhile, when the conveyor apparatus 1 is used as a low performance conveyor apparatus, that is, when the conveyor apparatus 1 is subjected to a manual operation, an operator may operate the switch section 24a on the inverter-side operation panel 21 (or the servo-side operation panel 22), to switch the control of the motor 4 to the inverter control. Then, the operator may operate the conveyor apparatus 1 while manually adjusting the conveyance speed or the conveyance direction using, for example, the driving switch 25a, the stop switch 25b, the direction changeover switch 26, and the speed variable volume 27 of the inverter-side operation panel 21.

In addition, when the inverter control device 51 has a sensorless vector control function, the input of the encoder 13 becomes unnecessary, and thus, the encoder cable may remain being connected to the servo control device 41 even when the control of the motor 4 is switched to the inverter control. More detailed description on the method of operating the conveyor apparatus will follow herein below.

### 1-5. Effects of First Embodiment

As described above, the conveyor apparatus 1 of the present embodiment includes the conveyor frame 2, the belt 3 provided on the conveyor frame 2, the motor 4 that drives the belt 3, and the control device 40 that controls the motor 4. The control device 40 includes the servo control device 41 that controls the motor 4 based on a command from the controller 300, the inverter control device 51 that controls the speed of the motor 4 based on an input signal from the speed variable volume 27, and the control changeover switch 24 that performs a switching between the servo control device 41 and the inverter control device 51. As a result, the following effects are exhibited.

That is, according to the conveyor apparatus 1 of the present embodiment, a user may switch the control of the motor 4 either to the servo control or to the inverter control using the control changeover switch 24. With the switching to the servo control, the conveyor apparatus 1 may be used as a high performance conveyor apparatus capable of performing an advanced control of synchronization with, for example, a robot or a working device provided in the conveyance line. In addition, with the switching to the inverter control, the conveyor apparatus 1 may be used as a low performance conveyor apparatus of which conveyance speed is manually adjusted by the speed variable volume 27. Accordingly, for example, when the automation is progressed by providing a robot or a working device in the conveyance line due to an increase in conveyance volume or a variance in conveyance contents, the conveyor apparatus may be used as a high performance conveyor apparatus with the switching to the servo control. In the meantime, for example, when the manual operation is progressed by arranging human workers in the conveyance line due to a decrease in the conveyance volume or a variance in the conveyance contents, the conveyor apparatus may be used as a low performance conveyor apparatus with the switching to the inverter control. In this way, the conveyor apparatus 1 may flexibly cope with even a case where the conveyance volume or the conveyance contents in the conveyance line vary according to, for example, market trends or seasons. As a result, since the number of conveyor apparatuses which become idling facilities may be reduced, the retraction space for an idling facility may also be reduced, and, as a result, the investment may be more effectively utilized.

In addition, in the present embodiment, especially, the control device 40 includes the servo-side operation panel 22 that performs an operation input to the servo control device 41 and the inverter-side operation panel 21 that includes the speed variable volume 27 and performs an operation input to the inverter control device 51. As a result, since the various operation input devices related to the servo control device 41 and the various operation input devices related to the inverter control device 51 may be distributed and arranged on the operation panels 21 and 22, respectively, the operability of the control device 40 may be improved. Further, it is possible to suppress a confusion between the operation to the servo control device 41 and the operation to the inverter control device 51, or an erroneous operation.

In addition, in the present embodiment, especially, the control device 40 includes the control box 20 in which the servo-side operation panel 22 and the inverter-side operation panel 21 are arranged to face different directions (e.g., opposite directions with each other). As a result, since only the inverter-side operation panel 21 or the servo-side operation panel 22 which becomes an operation target may be disposed to face the technician or operator, the effects in improving the operability and suppressing an erroneous operation may be enhanced.

In addition, in the present embodiment, especially, the servo-side operation panel 22 and the inverter-side operation panel 21 are arranged at different sides in the control box 20 to face one side and the other side of the conveyor apparatus 1 in the width direction, respectively. As a result, the following effects are exhibited.

That is, according to the present embodiment, it is possible to implement a use aspect where the disposition direction of the conveyor apparatus 1 is reversed (e.g., rotated 180° around the vertical axis) according to whether the conveyor apparatus 1 is used as a high performance conveyor or a low performance conveyor. As a result, since the operation panel which is not an operation target may be disposed to face the back side of the conveyor apparatus 1, the effect in suppressing an erroneous operation may be further enhanced. Further, since the disposition of the conveyor apparatus 1 clarifies whether the conveyor apparatus 1 is used as a high performance conveyor or a low performance conveyor, the convenience may be improved.

In addition, in the present embodiment, especially, the servo-side operation panel 22 includes the first connector 28a that communicates with the controller 300 and the second connector 28b that communicates with the encoder 13 provided in the motor 4, and the inverter-side operation panel 21 includes the speed variable volume 27, and the driving switch 25a and the stop switch 25b that switch the driving and stop of the motor 4.

As a result, since the servo control device 41 and the controller 300 may be connected to each other via the first connector 28a of the servo-side operation panel 22, and the servo control device 41 and the encoder 13 may be connected to each other via the second connector 28b, it is possible to cause the conveyor apparatus 1 to execute, for example, an advanced positioning operation which is synchronized with, for example, a robot or a working device. Further, by using the speed variable volume 27, the driving switch 25a, and the stop switch 25b of the inverter-side operation panel 21, the user may manually and flexibly change, for example, the driving, stop, and conveyance speed of the conveyor apparatus 1 according to, for example, a conveyance volume or manual works.

### 2. Second Embodiment

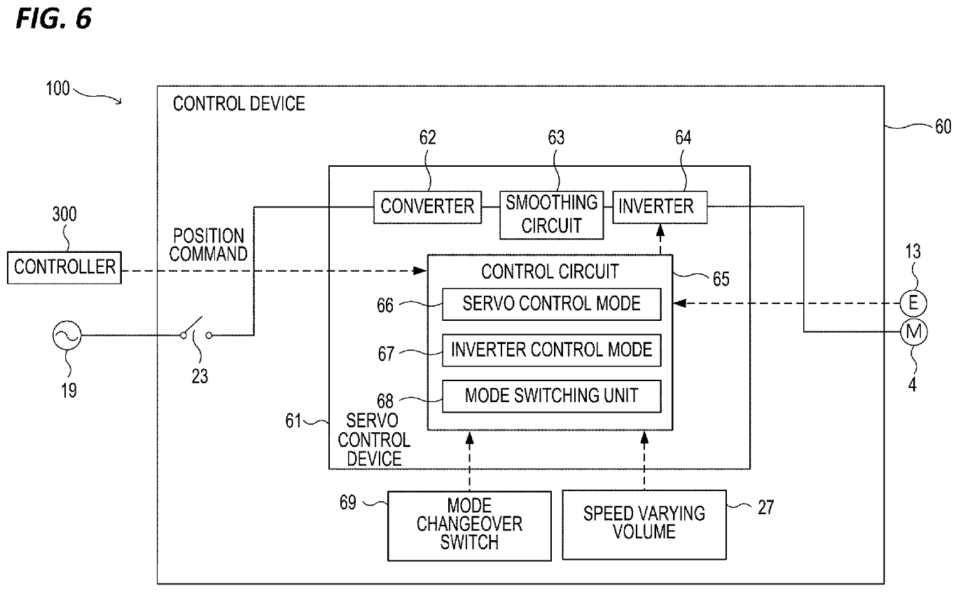

Next, a second embodiment will be described. In the first embodiment described above, the control device 40 is configured to include the two control devices including the servo control device 41 and the inverter control device 51. However, the present disclosure is not limited thereto. For example, a single servo control device may be provided, and a speed control function of the corresponding servo control device may be used as an inverter controller. FIG. 6 illustrates an example of a functional configuration of the control device in the conveyor apparatus of the second embodiment.

The conveyor apparatus 1 according to the second embodiment includes a control device 60, instead of the control device 40 of FIG. 5. In addition, since the configuration other than the control device is the same as that of the first embodiment, descriptions thereof will be omitted.

As illustrated in FIG. 6, the control device 60 includes only a servo control device 61 and does not include an inverter control device. The servo control device 61 includes a converter 62, a smoothing circuit 63, an inverter 64, and a control circuit 65. The control circuit 65 includes a servo control mode 66 (e.g., an example of a first controller and an example of a first control mode), an inverter control mode 67 (e.g., an example of a second controller and an example of a second control mode), and a mode switching unit 68. Further, on the inverter-side operation panel 21 and the servo-side operation panel 22 of the control box 20 of the control device 60, a mode changeover switch 69 (e.g., an example of a second operation input unit) is provided, instead of the control changeover switch 24. The mode switching unit 68 performs a switching between the servo control mode 66 and the inverter control mode 67 based on an input signal from the mode changeover switch 69.

The control circuit 65 switched to the servo control mode 66 controls the inverter 64 based on a deviation between a position command (or a speed command) from the controller 300 and a detected position (or a detected speed) of the motor 4 which is fed back from the encoder 13. In this way, the servo control device 61 controls the rotational position (or rotation speed) of the motor 4 based on the command from the controller 300, in the servo control mode 66.

The control circuit 65 switched to the inverter control mode 67 controls the inverter 64 based on an input signal from the speed variable volume 27. In this way, the servo control device 61 controls the speed of the motor 4 based on the input signal from the speed variable volume 27, in the inverter control mode 67.

In addition, the controller 300 and the conveyor apparatus 1 in which the servo control device 61 is switched to the servo control mode 66 constitute the conveyor system 100.

In addition, for example, the foregoing processes in the control circuit 45 and other elements are not limited to the example of the process distribution described above, and for example, the processes may be performed by a smaller number of processing units (e.g., a single processing unit) or further sub-divided processing units. In addition, in the servo control device 61, only the portions that supply the driving power to the motor 4 (e.g., the converter, the smoothing circuit, and the inverter) may be implemented by actual devices, and the other functions may be implemented by computer programs executed by the CPU 901 to be described later (see, e.g., FIG. 11). In addition, a portion or entire portion of the servo control device 61 may be implemented by actual devices such as an ASIC, an FPGA, and other electric circuits.

In addition, the servo control device 61 of the present embodiment may be implemented by, for example, adding software of a speed control system to software of a position control system of a general servo control device and allocating an external mode changeover switch 69 to an appropriate contact. When the conveyor apparatus is used as a low performance conveyor apparatus with the switching to the inverter control mode 67, for example, the external speed variable volume 27 and driving and stop switches 25a and 25b may be allocated to appropriate contacts, such that the same operation as that of the inverter control device 51 described above may be performed.

As described above, according to the present embodiment, the servo control device 61 includes the two control modes (e.g., the servo control mode 66 and the inverter control mode 67), and by switching the control modes, the conveyor apparatus 1 may be used either as a high performance conveyor or as a low performance conveyor. As a result, since it becomes unnecessary to newly provide a separate inverter control device from the servo control device 61, the circuit configuration may be simplified, and the control device 60 may be miniaturized.

### 3. Third Embodiment

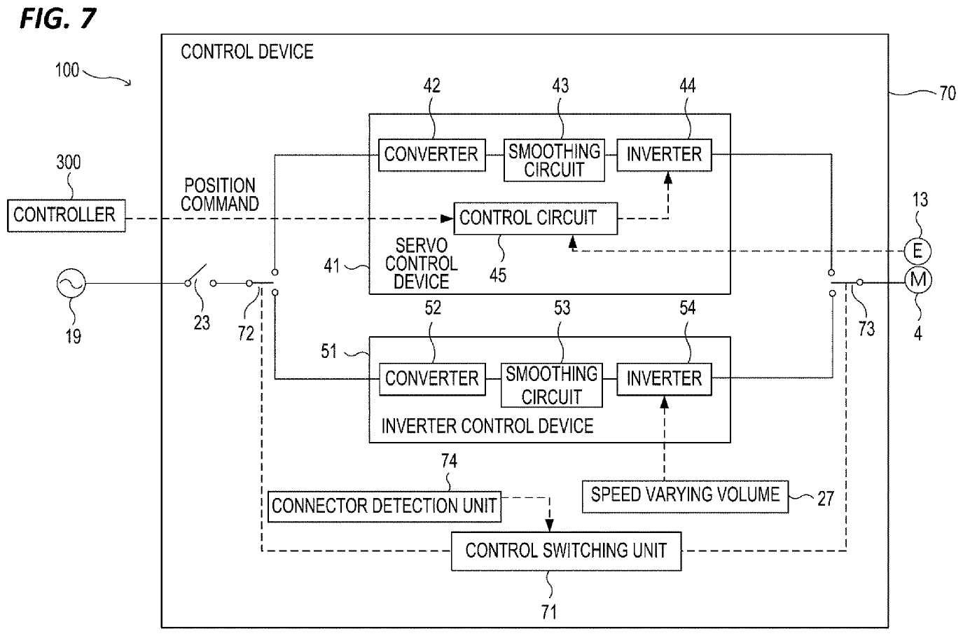

Next, a third embodiment will be described. In the first and second embodiments described above, the servo control and the inverter control are switched to each other by a manual operation. However, the present disclosure is not limited thereto. For example, the servo control and the inverter control may be automatically switched to each other according to, for example, a switching signal from an external device or a presence/an absence of a cable connection to the connector 28. FIG. 7 illustrates an example of a functional configuration of the control device in the conveyor apparatus of the third embodiment.

As illustrated in FIG. 7, the control device 70 of the present embodiment includes the above-described servo control device 41 and inverter control device 51, and a control switching unit 71 that performs a switching between the servo control device 41 and the inverter control device 51. The control switching unit 71 automatically performs the switching between the servo control device 41 and the inverter control device 51 by controlling the operations of switches 72 and 73 configured by, for example, relays. The control switching unit 71 may switch the control based on a switching signal from the outside (e.g., a host controller, an external terminal, or an external switch). In addition, as illustrated in FIG. 7, a connector detection unit 74 may detect a presence/an absence of a cable connection to the connector 28 (at least one of the connectors 28a to 28c) of the servo-side operation panel 22, and the control switching unit 71 may switch the control to the servo control device 41 when the connector detection unit 74 detects the presence of the cable connection, and switch the control to the inverter control device 51 when the connector detection unit 74 detects the absence of the cable connection.

According to the present embodiment, since the control device 70 may be automatically switched to an appropriate control, the control switching operation by a technician becomes unnecessary, so that the convenience of the technician may be improved.

### 4. Modified Embodiments

The embodiments of the present disclosure are not limited to the embodiments described above, and various modifications may be made within the scope that does not depart from the gist and the technical idea of the present disclosure. Hereinafter, the modifications will be described.

(4-1. Cover is Provided in Operation Panel not being Used)

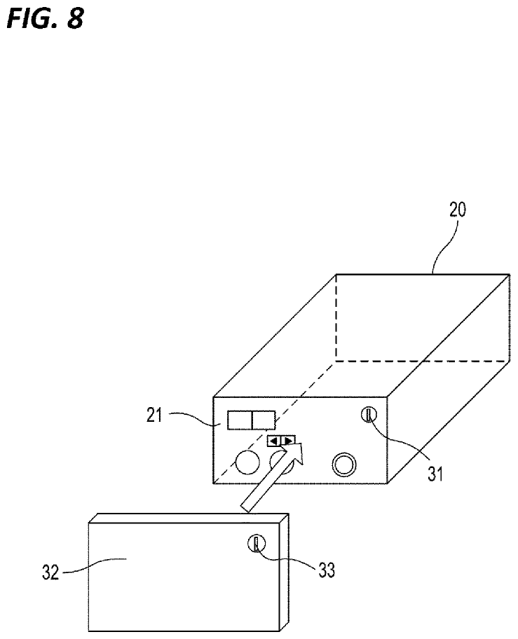

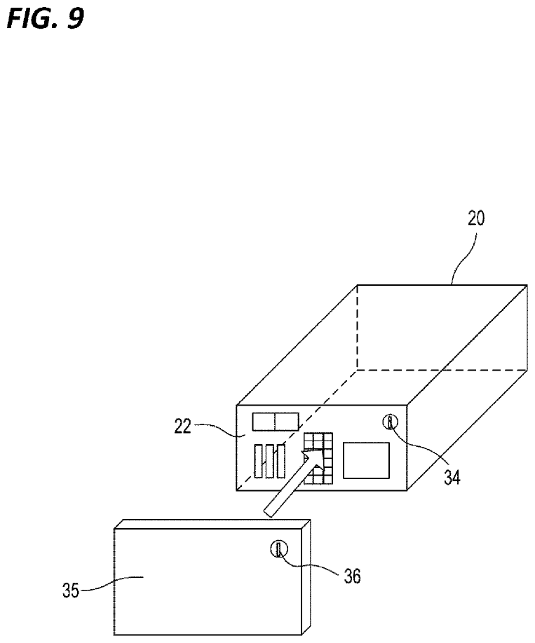

Although not provided in the embodiments described above, for example, a cover may be provided in an operation panel not being used, in order to suppress a confusion of an operation or an erroneous operation. In this case, the control of the motor 4 may be switched by an operation with, for example, a key for fixing the cover. FIGS. 8 and 9 illustrate an example of a configuration of the present modified embodiment.

As illustrated in FIG. 8, in the inverter-side operation panel 21 of the control box 20, a key insertion opening 31 is provided, instead of the control changeover switch 24. The key insertion opening 31 has the same function as that of the control changeover switch 24, and when a key (not illustrated) is inserted into the key insertion opening 31 and rotated by a predetermined amount, the control is switched to the servo control. Since the other configuration of the inverter-side operation panel 21 is the same as described above in FIG. 2, descriptions thereof will be omitted. When the control is switched to the servo control, a cover 32 may be provided in the inverter-side operation panel 21 not being used. The cover 32 is also provided with a key insertion opening 33 for fixing the cover 32 at the position corresponding to the key insertion opening 31.

When the control of the motor 4 is switched to the servo control, the cover 32 is provided in the inverter-side operation panel 21. Then, when a key (not illustrated) is inserted from the key insertion opening 33 of the cover 32 and rotated by a predetermined amount, the cover 32 is fixed to the inverter-side operation panel 21, and the control is switched to the servo control.

As illustrated in FIG. 9, instead of the control changeover switch 24, a key insertion opening 34 is provided in the servo-side operation panel 22 of the control box 20. The key insertion opening 34 has the same function as that of the control changeover switch 24, and when a key (not illustrated) is inserted into the key insertion opening 34 and rotated by a predetermined amount, the control is switched to the inverter control. Since the other configuration of the servo-side operation panel 22 is the same as described above in FIG. 4, descriptions thereof will be omitted. When the control is switched to the inverter control, a cover 35 may be provided in the servo-side operation panel 22 not being used, and the cover 35 is also provided with a key insertion opening 36 for fixing the cover 35 at the position corresponding to the key insertion opening 34.

In order to switch the control of the motor 4 to the inverter control, the cover 35 is provided in the servo-side operation panel 22. Then, when a key (not illustrated) is inserted from the key insertion opening 36 of the cover 35 and rotated by a predetermined amount, the cover 35 is fixed to the servo-side operation panel 22, and the control is switched to the inverter control.

In addition, in the modified embodiment above, the control is switched by the operation with the key. However, the operation with the key may be performed only for fixing the cover, and the switching of the control may be performed by the control changeover switch 24. In addition, instead of the switching by the key, for example, a proximity switch such as a magnet switch may be provided in each of the inverter-side operation panel 21 and the servo-side operation panel 22 of the control box 20, and may detect the approach of the covers 32 and 35 to switch the control.

(4-2. Inverter-Side Operation Panel and Servo-Side Operation Panel are Arranged Side by Side)

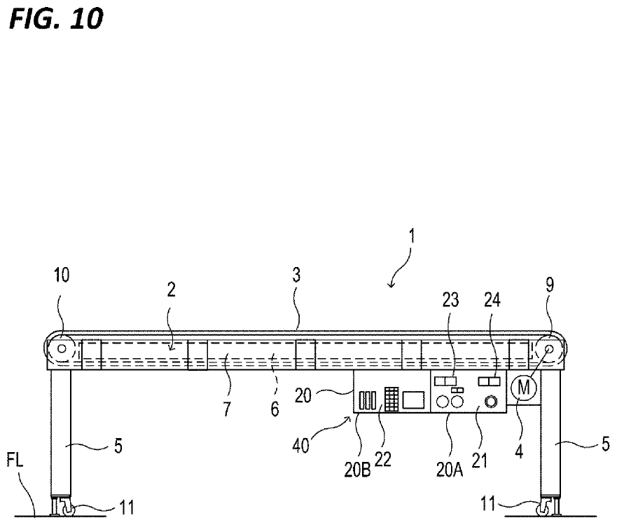

In the embodiments described above, the inverter-side operation panel 21 and the servo-side operation panel 22 are arranged at different sides to face one side and the other side of the conveyor apparatus 1 in the width direction. However, for example, the panels may be arranged side by side at the same side to face the same direction. FIG. 10 illustrates an example of the present modified embodiment.

As illustrated in FIG. 10, the control box 20 of the conveyor apparatus 1 of the present modified embodiment includes two control boxes 20A and 20B, and the control boxes 20A and 20B are arranged side by side in the conveyance direction. The control boxes 20A and 20B may be configured as separate bodies or as a single body. The inverter-side operation panel 21 is provided on one side of the control box 20A in the width direction, the servo-side operation panel 22 is provided on one side of the control box 20B in the width direction, and the inverter-side operation panel 21 and the servo-side operation panel 22 are arranged to face the same direction. The power supply switch 23 and the control changeover switch 24 may not be provided on both of the inverter-side operation panel 21 and the servo-side operation panel 22, and thus, are provided on only one of the inverter-side operation panel 21 and the servo-side operation panel 22, that is, the inverter-side operation panel 21 in the present example.

According to the present modified embodiment, both the inverter-side operation panel 21 and the servo-side operation panel 22 may be arranged to face the user, without changing the direction of the conveyor apparatus 1, for example, by rotating the conveyor apparatus 1 by 180° around the vertical axis. In addition, in the present modified embodiment, the cover described above may be provided on the operation panel not being used.

(4-3. Control Box is Configured to be Rotatable)

While the control box 20 is provided to be fixed to the conveyor apparatus 1 in the descriptions above, the control box 20 may be provided to be rotatable with respect to the conveyor apparatus 1. FIG. 11 illustrates an example of the present modified embodiment.

As illustrated in FIG. 11, in the present modified embodiment, the control box 20 is rotatably supported to the lower surface of the conveyor apparatus 1 via a rotation mechanism 38. The inverter-side operation panel 21 is disposed on one surface of the control box 20 in the horizontal direction, and the servo-side operation panel 22 is disposed on another surface of the control box 20 in the horizontal direction, that is, a surface which is adjacent to and different 90° in direction from the surface on which the inverter-side operation panel 21 is disposed. In addition, the operation panels 21 and 22 may be disposed on surfaces which are different 180° in direction from each other, respectively.

According to the present modified embodiment, either one of the inverter-side operation panel 21 or the servo-side operation panel 22 which is an operation target may be disposed to face the user by an easy operation to rotate the control box 20.

### 5. Example of Hardware Configuration of Controller

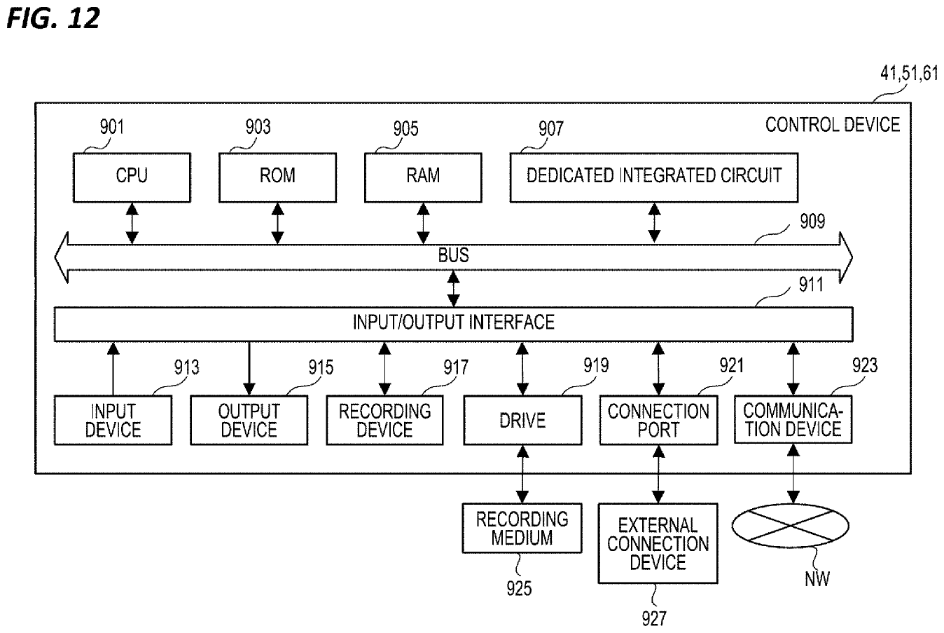

Next, referring to FIG. 12, descriptions will be made on an example of a hardware configuration of the control devices 41, 51, and 61 (the servo control devices 41 and 61 and the inverter control device 51) that implement the processes by, for example, the control circuit 45 implemented by programs executed by the CPU 901 described above. In addition, FIG. 12 appropriately omits the illustration of the configuration related to the function that supplies the driving power to the motor 4 of each of the control devices 41, 51, and 61.

As illustrated in FIG. 12, each of the control devices 41, 51, and 61 includes, for example, the CPU 901, a ROM 903, a RAM 905, a dedicated integrated circuit 907 constructed for a specific application such as an ASIC or an FPGA, an input device 913, an output device 915, a recording device 917, a drive 919, a connection port 921, and a communication device 923. These components are connected to each other to be able to exchange signals with each other through a bus 909 or an input/output interface 911.

The programs may be recorded in, for example, the ROM 903, the RAM 905 or the recording device 917.

In addition, the programs may be transitorily (temporarily) or non-transitorily (permanently) recorded in a removable recording medium 925, for example, a magnetic disk such as a flexible disk, an optical disk such as various CD, MO disk, and DVD, or a semiconductor memory. The recording medium 925 may be provided as so-called package software. In this case, the programs recorded in the recording medium 925 may be read by the drive 919, and recorded in the recording device 917 via, for example, the input/output interface 911 or the bus 909.

In addition, the programs may be recorded in, for example, a download site, another computer or another recording device (not illustrated). In this case, the programs are transferred via a network NW such as the LAN or the Internet, and the communication device 923 receives the programs. In addition, the programs received by the communication device 923 may be recorded in the recording device 917 via, for example, the input/output interface 911 or the bus 909.

In addition, the programs may be recorded in, for example, an appropriate external connection device 927. In this case, the programs may be transferred via an appropriate connection port 921, and recorded in the recording device 917 via, for example, the input/output interface 911 or the bus 909.

Then, when the CPU 901 executes various processes according to the programs recorded in the recording device 917, the processes by, for example, the control circuit 45 are implemented. At this time, for example, the CPU 901 may directly read the programs from the recording device 917 and execute the programs, or may temporarily load the programs in the RAM 905, and then, execute the programs. In addition, for example, when the programs are received via the communication device 923, the drive 919 or the connection port 921, the CPU 901 may directly execute the received programs without recording the programs in the recording device 917.

In addition, the CPU 901 may perform various processes, as necessary, based on signals or information input from the above-described input key 29 or the input device 913 such as a mouse, a keyboard or a microphone (not illustrated).

Then, the CPU 901 may output the result of the execution of the processes described above, from the above-described display 30 or the output device 915 such as a display device or an audio output device. In addition, the CPU 901 may transmit the result of the processes via the communication device 923 or the connection port 921, or may record the result of the processes in the recording device 917 or the recording medium 925, as necessary.

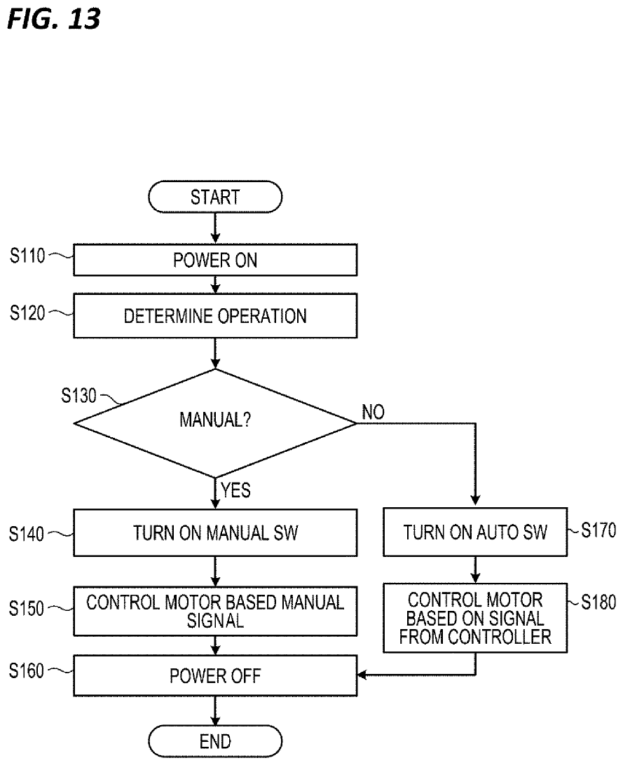

Next, referring to FIG. 13, descriptions will be made on an example of an operation of the conveyor apparatus according to an embodiment. At step S110, an operator of the conveyor apparatus may turn ON the power of the conveyor apparatus by, for example, manipulating the switch section 23a of the power supply switch 23, as illustrated in FIGS. 2 and 4. At step S120, the operator may determine a type of operation between a manual operation (e.g., an inverter mode operation) and an automatic operation (e.g., a servo mode operation). At step S130, when it is determined that a manual operation is determined, the process proceeds with step S140. At step S140, the operator may turn ON the manual switch by, for example, turning ON the INV section 24a of the control changeover switch 24, as illustrated in FIGS. 2 and 4. Subsequently, at step S150, a control operation is performed with a manual mode. For example, it may be assumed that the operator adjusts the motor speed by, for example, adjusting the speed variable volume 27 as illustrated in FIG. 2, and a control for the motor 4 is manually performed based on a signal input from the speed variable volume 27, i.e., a control operation is made based on a manually input signal. After a period of operation, the power of the conveyor apparatus may be turned OFF. For example, at step S160, the operator of the conveyor apparatus may turn OFF the power of the conveyor apparatus by, for example, manipulating the switch section 23b of the power supply switch 23, as illustrated in FIGS. 2 and 4.

At step S130, when it is determined that an automatic operation is determined, the process proceeds with step S170. At step S170, the operator may turn ON the automatic switch by, for example, turning ON the SV section 24b of the control changeover switch 24, as illustrated in FIGS. 2 and 4. Subsequently, at step S180, a control operation is performed with an automatic mode. For example, it may be assumed that the control circuit 45 receives a control signal from the controller 300, and a control for the motor 4 is automatically performed based on the control signal input from the controller 300. After a period of operation, the power of the conveyor apparatus may be turned OFF. For example, at step S160, the operator of the conveyor apparatus may turn OFF the power of the conveyor apparatus by, for example, manipulating the switch section 23b of the power supply switch 23, as illustrated in FIGS. 2 and 4.

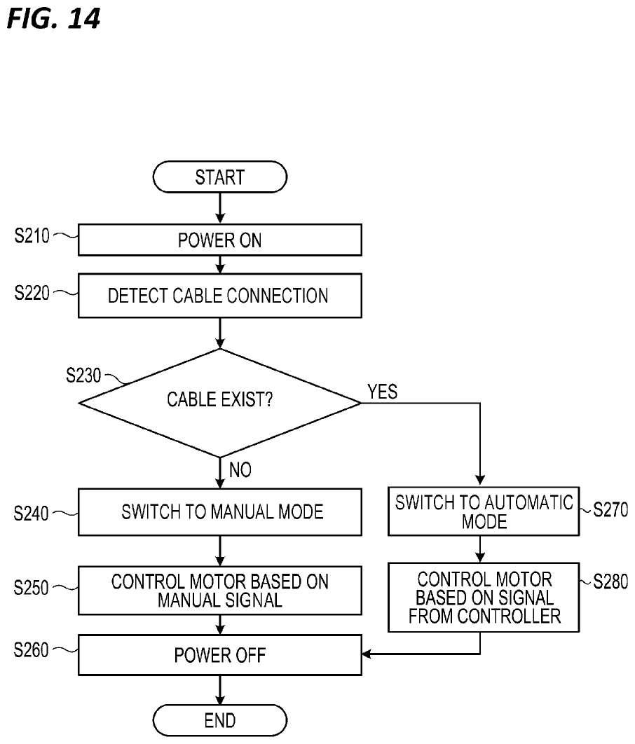

Next, referring to FIG. 14, descriptions will be made on an example of an operation of the conveyor apparatus according to another embodiment. At step S210, an operator of the conveyor apparatus may turn ON the power of the conveyor apparatus by, for example, manipulating the switch section 23a of the power supply switch 23, as illustrated in FIGS. 2 and 4. At step S220, the connector detection unit 74 may detect a presence or an absence of a cable connection to the connector 28. At step S230, when the connector detection unit 74 does not detect any cable connection to the connector 28 (i.e., when the connector detection unit 74 detects an absence of the cable connection), the process proceeds with step S240. At step S240, the conveyor apparatus may be switched to a manual mode. At step S250, a control operation is performed with a manual mode. For example, it may be assumed that the operator adjusts the motor speed by, for example, adjusting the speed variable volume 27 as illustrated in FIG. 2, and a control for the motor 4 is manually performed based on a signal input from the speed variable volume 27. After a period of operation by the conveyor apparatus, the power of the conveyor apparatus may be turned OFF. For example, at step S260, the operator of the conveyor apparatus may turn OFF the power of the conveyor apparatus by, for example, manipulating the switch section 23b of the power supply switch 23, as illustrated in FIGS. 2 and 4.

At step S230, when the connector detection unit detects a presence of a cable connection to the connector 28, the process proceeds with step S270. At step S270, the conveyor apparatus may be switched to an automatic mode. Subsequently, at step S280, a control operation is performed with an automatic mode. For example, it may be assumed that the control circuit 45 receives a control signal from the controller 300, and a control for the motor 4 is automatically performed based on the control signal input from the controller 300. After a period of operation, the power of the conveyor apparatus may be turned OFF. For example, at step S260, the operator of the conveyor apparatus may turn OFF the power of the conveyor apparatus by, for example, manipulating the switch section 23b of the power supply switch 23, as illustrated in FIGS. 2 and 4.

In the descriptions above, terms such as “vertical,” “parallel,” and “plane” do not have a strict meaning and may be interpreted with a margin. That is, the terms such as “vertical,” “parallel,” and “plane” may indicate “substantially vertical,” “substantially parallel,” and “substantially plane” to allow a tolerance and an error in design and manufacturing.

Also, in the descriptions above, terms such as “the same,” “identical,” “equal,” and “different” with respect to, for example, a size, a shape, and a position in an appearance do not have a strict meaning and may be interpreted with a margin. That is, the terms “the same,” “identical,” “equal,” and “different” may indicate “substantially the same,” “substantially identical,” “substantially equal,” and “substantially different” to allow a tolerance and an error in design and manufacturing.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A conveyor apparatus comprising:
a conveyor frame;
a conveyor provided in the conveyor frame;
a motor configured to drive the conveyor;
control circuitry configured to control the motor, and including a first controller configured to control a position of the motor based on a position command from a host controller and a second controller configured to control a speed of the motor based on an input signal from a first operation input switch;
a first operation panel configured to perform an operation input to the first controller;
a second operation panel provided with the first operation input switch and configured to perform an operation input to the second controller; and
a housing integrally equipped with the first operation panel and the second operation panel.

2. The conveyor apparatus according to claim 1, wherein the housing includes:
a second operation input switch configured to select one of the first controller and the second controller such that the control circuitry is switched to a selected controller.

3. The conveyor apparatus according to claim 1, wherein the first operation panel and the second operation panel are arranged in the housing to face different directions from each other.

4. The conveyor apparatus according to claim 3, wherein the first operation panel and the second operation panel are arranged in the housing to face one side and the other side of the conveyor apparatus, respectively, in a direction perpendicular to a conveyance direction of the conveyor apparatus.

5. The conveyor apparatus according to claim 1, wherein the first operation panel includes:
a first connector configured to communicate with the host controller, and
a second connector configured to communicate with an encoder provided in the motor, and
the second operation panel includes:
the first operation input switch, and
a third operation input switch configured to perform a switching between a driving and a stop of the motor.

6. The conveyor apparatus according to claim 1, wherein the conveyor apparatus includes:
a mode switch configured to perform a switching between a first control mode serving as the first controller and a second control mode serving as the second controller, based on an input signal from the second operation input switch.

7. The conveyor apparatus according to claim 1, wherein the conveyor apparatus includes:
a control switch configured to perform a switching of the control circuitry between the first controller and the second controller.

8. The conveyor apparatus according to claim 7, wherein the conveyor apparatus includes:
a first connector configured to communicate with the host controller, and
a connector detector configured to detect a presence or an absence of a cable connection to the first connector, and
wherein the control switch performs a switching to the first controller when the connector detector detects the presence of the cable connection, and performs a switching to the second controller when the connector detector detects the absence of the cable connection.

9. The conveyor apparatus according to claim 1, wherein the housing is provided to be rotatable such that a direction of the first operation panel and the second operation panel is rotatably changed.

10. The conveyor apparatus according to claim 1, further comprising a cover configured to cover either one of the first operation panel and the second operation panel when the either one of the first operation panel and the second operation panel is not in use.

11. A conveyor system comprising:
a host controller; and
the conveyor apparatus according to claim 1 that is connected to the host controller to be able to communicate with the host controller.

12. A conveyor apparatus comprising:
a conveyor frame;
a conveyor provided in the conveyor frame;
a motor configured to drive the conveyor;
control circuitry configured to control the motor, and including a first controller configured to control a position of the motor based on a position command from a host controller and a second controller configured to control a speed of the motor based on an input signal from a first operation input switch;
a connector configured to communicate with the host controller; and
a control switch configured to perform a switching of the control circuitry to the first controller when the conveyor apparatus is connected to the host controller via the connector, and perform a switching of the control circuitry to the second controller when the conveyor apparatus is not connected to the host controller via the connector.

13. The conveyor apparatus according to claim 12, further comprising a connector detector configured to detect a presence or an absence of a cable connection to the connector,
wherein the control switch performs a switching to the first controller when the connector detector detects the presence of the cable connection, and performs a switching to the second controller when the connector detector detects the absence of the cable connection.

14. A method of operating a conveyor apparatus, the method comprising:
providing the conveyor apparatus including:
a conveyor frame,
a conveyor provided in the conveyor frame,
a motor configured to drive the conveyor,
control circuitry configured to control the motor, and including a first controller configured to control a position of the motor based on a position command from a host controller and a second controller configured to control a speed of the motor based on an input signal from a first operation input switch,
a first operation panel configured to perform an operation input to the first controller,
a second operation panel provided with the first operation input switch and configured to perform an operation input to the second controller, and
a housing integrally equipped with the first operation panel and the second operation panel, and
switching the control circuitry to the first controller, when the conveyor apparatus is subjected to an automatic operation; and
switching the control circuitry to the second controller, when the conveyor apparatus is subjected to a manual operation.

15. The method according to claim 14, further comprising determining between the automatic operation and the manual operation based on a signal from a second operation input switch provided in the housing.

16. A method of operating a conveyor apparatus, the method comprising:
providing the conveyor apparatus including:
a conveyor frame,
a conveyor provided in the conveyor frame,
a motor configured to drive the conveyor,
control circuitry configured to control the motor, and including a first controller configured to control a position of the motor and a second controller configured to control a speed of the motor,
a connector configured to communicate with a host controller, and
a control switch configured to perform a switching of the control circuitry between the first controller and the second controller,
switching, by the control switch, to the first controller when the conveyor apparatus is connected to the host controller via the connector; and
switching, by the control switch, to the second controller when the conveyor apparatus is not connected to the host controller via the connector.

17. The method of operating the conveyor apparatus according to claim 16, wherein the conveyor apparatus includes a connector detector configured to detect a presence or an absence of a cable connection to the connector,
the method further comprising:
detecting, by the connector detector, the presence or the absence of the cable connection to the connector,
wherein the switching, by the control switch, to the first controller is performed when the connector detector detects the presence of the cable connection, and
the switching, by the control switch, to the second controller is performed when the connector detector detects the absence of the cable connection.

18. The method of operating the conveyor apparatus according to claim 16, wherein the first controller represents an automatic operation in which the conveyor apparatus is automatically controlled based on a position command from the host controller, and the second controller represents a manual operation in which the conveyor apparatus is manually controlled based on an input signal from an operation input switch provided in the conveyor apparatus.
